(19) United States
(12) Patent Application Publication
(10) Pub. No.: US 2003/0154148 A1
(43) Pub. Date: Aug. 14, 2003

(54) Launching via dynaquote

(76) Inventors: Christopher Kokis, Monroe, CT (US); Robert A. Waghorne, Fairfield, CT (US)

Correspondence Address: DENIS G. MALONEY, Fish & Richardson P.C., 225 Franklin Street, Boston, MA, 02110-2804, US

(21) Appl. No.: 10/294,458

(22) Filed: Nov. 14, 2002

Related U.S. Application Data
(60) Provisional application No. 60/335,388, filed on Nov. 14, 2001.
(60) Provisional application No. 60/385,979, filed on Jun. 5, 2002.
(60) Provisional application No. 60/385,988, filed on Jun. 5, 2002.

(51) Int. Cl. G06F 17/60

(52) U.S. Cl. 705/35

(57) ABSTRACT

An aggregated display process includes a display process for displaying, in a multicolumn format, an entry for a specific security that is sought for purchase or offered for sale by a market participant on a securities market. These entries, which can be bid-side entries or ask-side entries, each include a market participant identifier, a lot size, and a bid or ask price. The display process includes a tabular display process for simultaneously displaying multiple entries in a table. An aggregate calculation process generates an aggregate value for a specific entry. This aggregate value is equal to the lot size of the specific entry summed with the lot sizes of all preceding entries included in the table.

### RELATED APPLICATIONS

This application claims the priority of: U.S. Provisional Patent Application No. 60/335,388, entitled “Super Montage”, and filed on Nov. 14, 2001; U.S. Provisional Patent Application No. 60/385,979, entitled “Supermontage Architecture”, and filed on Jun. 5, 2002; and U.S. Provisional Patent Application No. 60/385,988, entitled “Security Processor”, and filed on Jun. 5, 2002.

### BACKGROUND

This invention relates to electronic securities trading, and the processing and displaying of information relating to electronic securities trading.

Electronic equity markets collect, aggregate, and display pre-trade information to market participants. This pre-trade information takes the form of a quote that represents a single or an aggregate of same-priced principal or agency orders. A market, such as The Nasdaq Stock Market™, also provides trading platforms through which market participants may trade securities in the marketplace.

### SUMMARY

According to an aspect of this invention, an aggregated display process includes a display process for displaying, in a multi-column format, an entry for a specific security that is sought for purchase or offered for sale by a market participant on a securities market. These entries can be bid-side entries or ask-side entries. This entry includes a market participant identifier, a lot size, and a bid or ask price. The display process includes a tabular display process for simultaneously displaying multiple entries in a table. An aggregate calculation process generates an aggregate value for a specific entry. This aggregate value is equal to the lot size of the specific entry summed with the lot sizes of all preceding entries included in the table.

One or more of the following features may also be included. The display process includes a tabular sorting process for sorting the multiple entries in accordance with a user-defined sorting parameter, such as a market participant identifier; a lot size; or an ask price. A selection process allows a market participant to select one or more groups of entries that have a common ask or bid price. A security selection process allows a market participant to select the specific security. A security data display process displays trade data concerning the specific security, such as a trade volume amount, a low trade amount, or a high trade amount.

The above-described processes may also be implemented as a method or a sequence of instructions executed by a processor. One or more advantages can be provided from the above. The user can quickly and easily monitor all trading activity for a specific security. Further, selecting blocks of securities is simplified via a group selection process. Additionally, by including aggregate value information concerning the specific security, the purchasing decisions of market participants can be simplified. By providing the user with trade data concerning the security being monitored, the user is better able to judge the condition of the market concerning that specific security.

### DESCRIPTION OF DRAWINGS

FIG. 1 is a block diagram of an aggregated display process;

FIG. 2 is a diagrammatic view of an aggregated display;

FIG. 3 is a block diagram of an aggregated display method for ask-side entries; and

FIG. 4 is a block diagram of an aggregated display method for bid-side entries.

### DETAILED DESCRIPTION

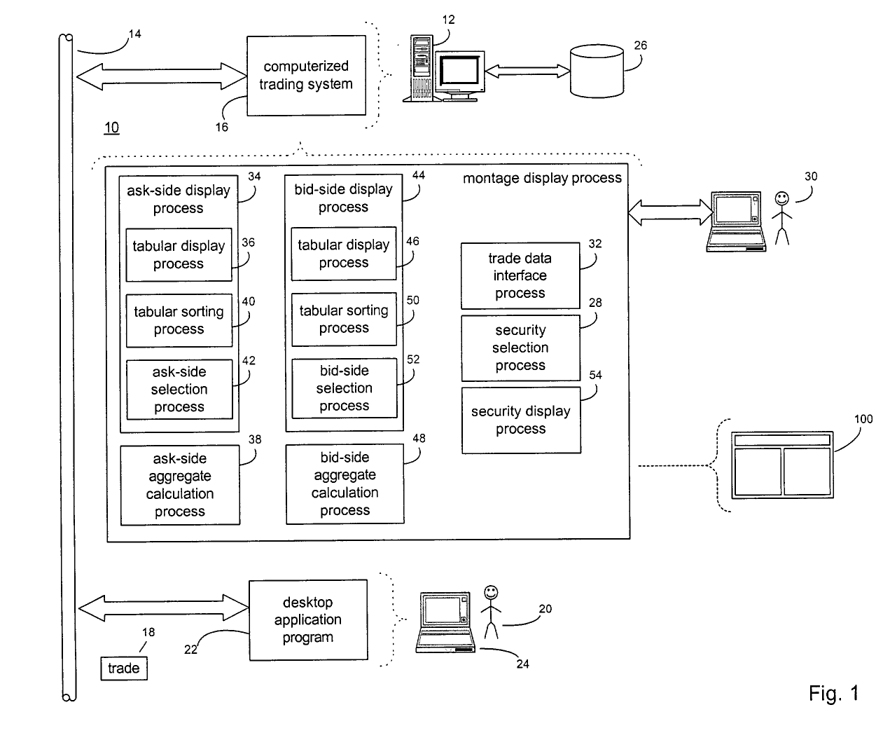

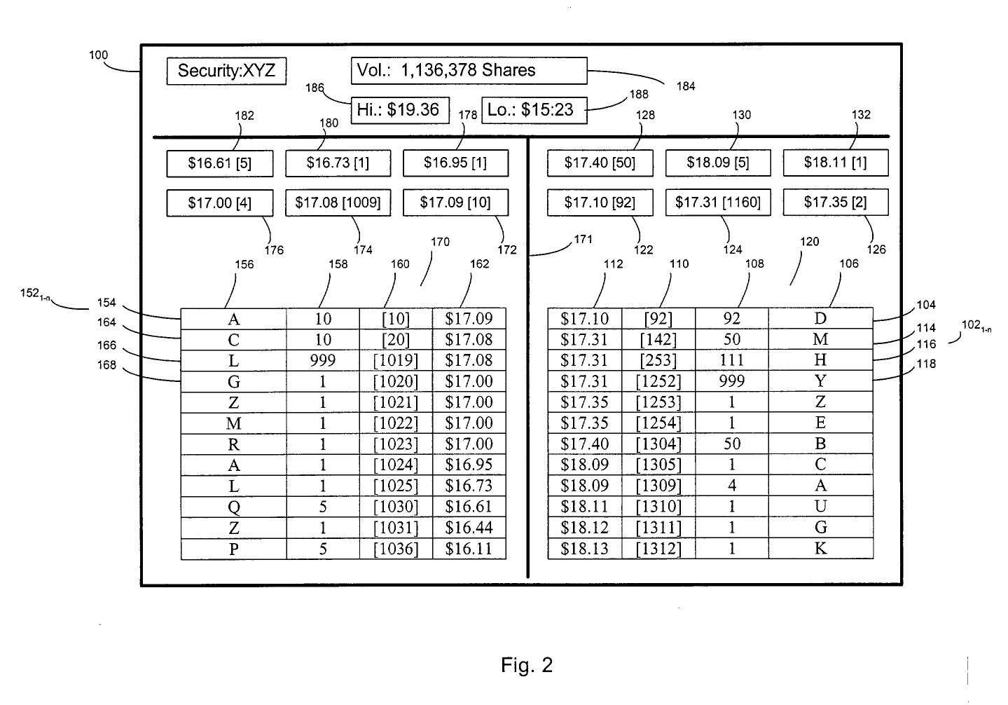

Referring to FIGS. 1 and 2, there is shown an aggregated display process 10. Aggregated display process 10 resides on server 12 that is connected to a distributed computing network 14 (e.g., the Internet, an intranet, a local area network, or some other form of network).

Computerized trading system 16 (e.g., The Nasdaq Stock Market™), which trades securities electronically and also resides on server 12, processes attributable security interest messages 18.

These messages, which are entered by market participants (e.g., market participant 20), concern a specific security sought for purchase or offered for sale on computerized trading system 16. Market participant 20 typically accesses and uses computerized trading system 16 via a desktop application 22 (e.g., Microsoft Internet Explorer™, Netscape Navigator™, the Nasdaq Workstation II™, a specialized desktop interface, etc.) residing on a computer 24, thus allowing market participant 20 to trade securities with other market participants (not shown).

Aggregated display process 10 allows market participant 20 to monitor the trading activity for a specific security traded on computerized trading system 16, by providing market participant 20 with a aggregated display 100 (to be discussed below in greater detail) viewable on computer 24. Typically, aggregated display 100 is one screen in size, thus allowing market participant 20 to quickly get an overview of the activity of the specific security without having to scroll through or toggle between multiple screens.

Process 10 typically resides on a storage device 26 connected to server 12. Storage device 26 can be a hard disk drive, a tape drive, an optical drive, a RAID array, a random access memory (RAM), or a read-only memory (ROM), for example. Additionally, computerized trading system 16 stores all information relating to securities trades on storage device 26.

Process 10 includes a security selection process 28 that allows market participant 20 to select the specific security they wish to monitor. This selection may occur is several different ways and will vary depending on the manner in which process 10 is implemented and configured by administrator 30. For example, market participant 20 may select the security they wish to monitor via a drop-down menu that allows the market participant to scroll through a list of securities and select the one they wish to monitor. This drop down menu may utilize ticker symbols or may list the full name of the issuer of the security. Alternatively, market participant 20 may wish to enter the security's ticker symbol directly, thus allowing for quicker selection.

Once a selection is made, a trade data interface process 32 retrieves, from storage device 26 of server 12, the relevant trade data concerning the security selected by market participant 20. Typically, aggregated display 100 is a real-time display, in that the information shown within the display is regularly updated (at a frequency defined by administrator 30) so that it is always accurate and up to date. Accordingly, trade data interface process 32 typically establishes a connection (e.g., a socket) with computerized trading system 16 so that the information provided in display 100 is always relevant and up-to-date.

Once a connection is established by trade data interface process 32 and the relevant trade data is retrieved, aggregated display 100 is generated. As stated above, aggregated display 100 allows market participant 20 to quickly and easily discern the trading activity associated with the specific security that market participant 20 wishes to monitor.

An ask-side display process 34 displays, in a multi-column format, ask-side entries 102₁₋ₙ for the security that was selected by market participant 20, and is currently being traded on computerized trading system 16. Each discrete ask-side entry 102₁₋ₙ represents a discrete group of the specific security selected by market participant 20, such that these groups of securities are being offered for sale by another market participant. For example, ask-side entry 104 concerns a group of ninety-two shares of the security XYZ corp. that is currently being offered for sale by Market Participant D. Ask-side entry 104 includes multiple columns, each of which provides information concerning the discrete group of securities being offered for sale, such as a market participant indicator 106 (i.e., a unique symbol that identifies the market participant who is offering the security for sale), an ask price 112, a lot size 108 (i.e., the quantity of shares of the selected security available at that ask price from that market participant), and an aggregate value 110 (i.e., the total sum of shares available at that price or lower).

Ask-side display process 34 includes a tabular display process 36 for simultaneously displaying multiple ask-side entries (e.g., ask-side entries 104, 114, 116, 118). These ask-side entries are arranged vertically so that the market indicator, ask price, lot size, and aggregate value of each entry are aligned, forming ask-side table 120.

Therefore, for this particular aggregated display 100, if market participant 20 is willing to pay up to $17.10 for a share of XYZ corp., market participant 20 could buy up to ninety-two shares from Market Participant D. This is shown in ask-side entry 104. However, if market participant 20 desires a ninety-third share of XYZ corp., market participant 20 is going to have to pay $17.31 for that one additional share, since Market Participant D only has ninety-two shares for sale at $17.10 and the additional share is going to have to be purchased from Market Participant M for $17.31 (see ask-side entry 114). If, upon realizing that additional shares of XYZ corp. can be purchased for $17.31, market participant 20 wishes to purchase an additional one-hundred shares of XYZ corp., this is not a problem, as Market Participant M has fifty shares of XYZ corp. for sale for $17.31, Market Participant H has an additional one-hundred-eleven shares available for $17.31, and Market Participant Y has nine-hundred-ninety-nine shares available for $17.31. Therefore, a total of eleven-hundred-sixty shares of XYZ corp. are available for $17.31.

Process 10 includes an ask-side aggregate calculation process 38 for calculating the ask-side aggregate value 110 for each ask-side entry. Ask-side aggregate calculation process 38 determines the ask-side aggregate value 110 for a particular ask-side entry by summing the value of the lot size for that particular ask-side entry with the lot sizes of all preceding ask-side entries included in ask-side table 120. For example, the aggregate value for ask-side entry 104 is [92], the aggregate value for ask-side entry 114 is [142, i.e., 92+50], the aggregate value for ask-side entry 116 is [253, i.e., 92+50+111], and so forth.

A tabular sorting process 40 sorts ask-side entries (e.g., 104, 114, 116, 118) in accordance with a user-defined sorting parameter, such as ascending or descending ask prices, alphanumeric market participant ID's, ascending or descending lot sizes, for example. This enables market participant 20 to group and order the ask-side entries within ask-side table 120 in accordance with their personal preferences. For example, it market participant 20 wanted to know which groups of securities a particular market participant was offering for sale, market participant 20 could sort the ask-side entries by market participant. However, the ask-side entries within ask-side table 120 are typically sorted by ask price (as shown in FIG. 2).

An ask-side selection process 42 allows a market participant 20 to select (typically for purchase) groups of ask-side entries that have a common ask price. In order to facilitate this selection, aggregated display 100 includes group selection buttons 122, 124, 126, 128, 130, 132 that are each are assigned to a particular ask price. These buttons are dynamically updated by ask-side selection process 42 so that they accurately reflect the securities (e.g., XYZ corp.) currently being offered for sale on computerized trading system 16. For example, group selection button 122 represents shares of XYZ corp. available for $17.10. As discussed above, there are ninety-two of them, as represented by ask-side entry 104. Group selection button 124 represents shares of XYZ corp. available for $17.31. There are eleven-hundred-sixty of them, as represented by ask-side entries 114, 116, 118. By clicking on or otherwise selecting (with a mouse or other pointing device, not shown) any of these group selection buttons, market participant 20 can select groups of shares available at a particular ask price. As stated above, these buttons are dynamically updated, so that if ask-side entry 104 is sold (i.e., purchased by another market participant), there would be no more shares of XYZ corp. available for $17.10 and, therefore, group selection button 122 would be removed by ask-side selection process 42. Further, assuming that no additional shares of XYZ corp. became available at a price lower than $17.31, an additional group selection button (not shown) would be created that would indicate one share of XYZ corp. being available from Market Participant G for $18.12. Typically, group selection buttons 126, 128, 130, 132, 134, 136 are organized so that the ask price that each button is associated with increases as market participant 20 moves along any row of buttons from left to right.

In a manner similar to ask-side display process 34, a bid-side display process 44 displays, in a multi-column format, bid-side entries 152₁₋ₙ for the same security (i.e., XYZ corp.) that was selected by market participant 20. Each discrete bid-side entry 152₁₋ₙ represents a discrete group of the specific security (selected by market participant 20) that is sought for purchase by another market participant of computerized trading system 16. For example, bid-side entry 154 concerns a group of ten shares of the security XYZ corp. that a market participant (i.e., Market Participant A) currently wants to purchase. Similar to an ask-side entry, a bid-side entry 154 includes multiple columns, each of which provides information concerning the discrete group of securities sought for purchase, such as a market participant indicator 156 (i.e., a unique symbol that identifies the market participant who wants to purchase the security), a bid price 162, a lot size 158 (i.e., the quantity of shares of the selected security sought for purchase by that market participant at that bid price), and an aggregate value 160 (i.e., the total sum of shares sought for purchase at that price or higher).

Bid-side display process 44 includes a tabular display process 46 for simultaneously displaying multiple bid-side entries (e.g., bid-side entries 154, 164, 166, 168). These bid-side entries are arranged vertically so that the market indicator, bid price, lot size, and aggregate value of each entry are aligned, forming an bid-side table 170.

Therefore, for this particular aggregated display 100, if market participant 20 owns two-thousand shares of XYZ corp. that they are willing to sell but they do not want to sell them for less than $17.09 per share, market participant 20 can only sell ten shares to Market Participant A, as bid-side entry 154 specifies that $17.09 is the highest dollar amount offered to buy a share of XYZ corp. and Market Participant A is only willing to purchase ten shares at that price. However, if market participant 20 is willing to lower their sell price to $17.08 per share, market participant 20 can sell one-thousand-nineteen shares of XYZ corp. at that price. Specifically, Market Participant A is willing to buy ten shares for $17.09 (see bid-side entry 154), Market Participant C is willing to buy ten shares for $17.08 (see bid-side entry 164), and Market Participant L is willing to buy nine-hundred-ninety-nine shares for $17.08 (see bid-side entry 166).

Process 10 includes an bid-side aggregate calculation process 48 for calculating the bid-side aggregate value 160 for each bid-side entry. As with ask-side aggregate calculation process 38, bid-side aggregate calculation process 48 determines the bid-side aggregate value 160 for a particular bid-side entry by summing the value of the lot size for that particular bid-side entry with the lot sizes of all preceding bid-side entries included in bid-side table 170. For example, the aggregate value for bid-side entry 154 is [10], the aggregate value for bid-side entry 164 is [20, i.e., 10+10], the aggregate value for bid-side entry 166 is [1019, i.e., 10+10+999], and so forth.

Similar to that of ask-side entries, a tabular sorting process 50 sorts bid-side entries (e.g., 154, 164, 166, 168) in accordance with a user-defined sorting parameter, such as ascending or descending bid prices, alphanumeric market participant ID's, ascending or descending lot sizes, etc. This enables market participant 20 to group and order the bid-side entries within bid-side table 170 in accordance with their personal preferences. Again, like ask-side table 120, bid-side entries within bid-side table 170 are typically sorted by bid price (as shown in FIG. 2).

Bid-side display process 44 displays bid-side entries so that bid-side table 170 is essentially a mirror image of ask-side table 120. Specifically, the columns in bid-side table 170 are arranged in a fashion so that they are in the opposite order (i.e., when moved across the tables 120, 170 in a common direction) to that of ask-side table 120. The columns of these tables are essentially mirrored around an imaginary centerline 171. For example, column 112 and column 162 (i.e., ask prices and bid prices respectively) are the closest columns to centerline 171. Column 110 and column 160 (i.e., ask-side and bid-side aggregate values respectively) are the second closest columns to centerline 171. Further, column 108 and column 158 (i.e., ask-side and bid-side lot sizes respectively) are the third closest columns to centerline 171. And finally, column 106 and column 156 (i.e., ask-side and bid-side market participant ID's respectively) are the furthest columns away from centerline 171.

A bid-side selection process 52 allows a market participant 20 to select (typically for the purpose of selling the market participant's securities) groups of bid-side entries that have a common bid price. In order to facilitate this selection, aggregated display 100 includes group selection buttons 172, 174, 176, 178, 180, 182 that each are assigned to a particular bid price. The buttons are dynamically updated by bid-side selection process 52 so that they accurately reflect the securities currently sought for purchase. For example, group selection button 172 represents shares sought for purchase at $17.09. As discussed above, there are ten of them, as represented by bid-side entry 154. Group selection button 174 represents shares available for $17.08. There are one-thousand-nine of them, as represented by bid-side entries 164, 166. By clicking on or otherwise selecting (with a mouse or other pointing device, not shown) any of these group selection buttons, market participant 20 can select groups of shares that the other market participant (i.e., the market participant of the bid-side entry) wishes to purchase for a particular bid price.

These buttons are also dynamically updated, so that if bid-side entry 154 is filled (i.e., someone else sold Market Participant A ten shares of XYZ corp. for $17.09 per share), there would be no more market participants willing to pay $17.09 for a share of XYZ corp. and, therefore, group selection button 172 would be removed by bid-side selection process 52. Further, assuming that no other market participants were willing to pay more than $17.08 for a share of XYZ corp., an additional group selection button (not shown) would be created that would indicate that a market participant (i.e., Market Participant Z) was willing to pay $16.44 for one share of XYZ corp. Typically, group selection buttons 172, 174, 176, 178, 180, 182 are organized so that the bid price that each button is associated with decrease as market participant 20 moves along any row of buttons from right to left, an arrangement that is a mirror image of the ask-side group selection buttons (i.e., 122, 124, 126, 128, 130, 132).

A security display process 54 displays, in aggregated display 100, pertinent trade data relating to the specific security (e.g., XYZ corp.) being monitored by market participant 20. Examples of this pertinent trade data, which is retrieved from computerized trading system 16, include a daily trade volume amount indicator 184, daily high trade amount indicator 186, and daily low trade value amount indicator 188.

While the group selection buttons are shown arranged in groups of six, this is an arbitrary amount, as this number can be adjusted depending on the requirement of market participant 20 and administrator 30.

While the lot sizes 108, 158 described above are stated to be in units of shares, it is possible for these numbers to also represent groups of one-hundred shares (commonly referred to as “round lots”), or any other amount of shares. In this scenario, ask-side entry 104 may represent an offer to sell ninety-two-hundred shares of XYZ corp.

While imaginary centerline 171 is shown as being a vertical centerline, this imaginary centerline 171 may be a horizontal centerline, such that ask-side and bid-side entries are arranged in multi-row format and, therefore, mirroring would occur about a horizontal axis.

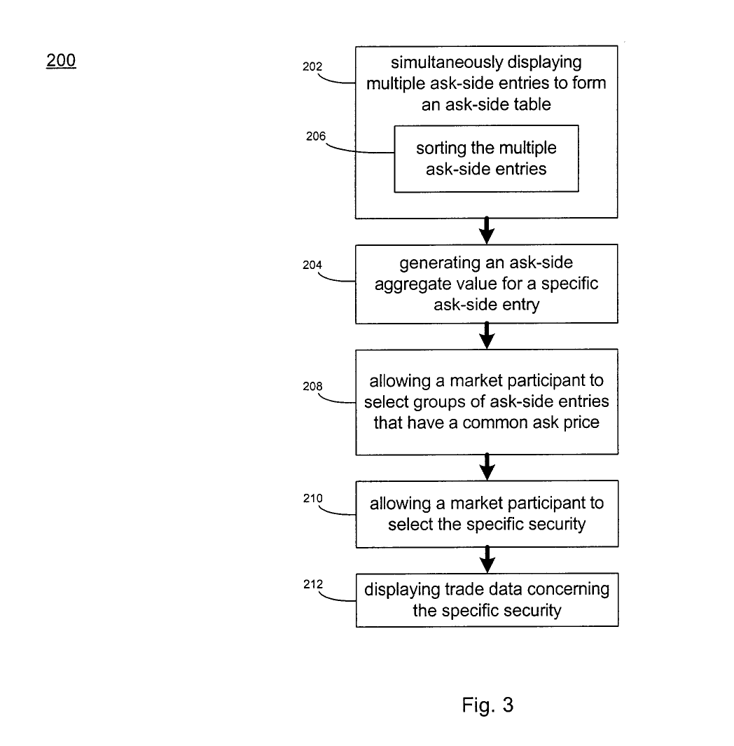

Referring to FIG. 3, there is shown an aggregated display method 200. Multiple ask-side entries are simultaneously displayed 202 to form an ask-side table. Each of these ask-side entries is in a multi-column format, concerns a specific security that is offered for sale by a market participant on a securities market, and includes a market participant identifier, a lot size, and an ask price.

An ask-side aggregate value is generated 204 for a specific ask-side entry. This ask-side aggregate value is equal to the lot size of that specific ask-side entry summed with the lot sizes of all preceding ask-side entries included in the ask-side table.

The ask-side entries are sorted 206 in accordance with a user-defined sorting parameter. A market participant is allowed 208 to select groups of ask-side entries that have a common ask price, and is also allowed 210 to select the specific security. Additionally, trade data is displayed 212 concerning the specific security.

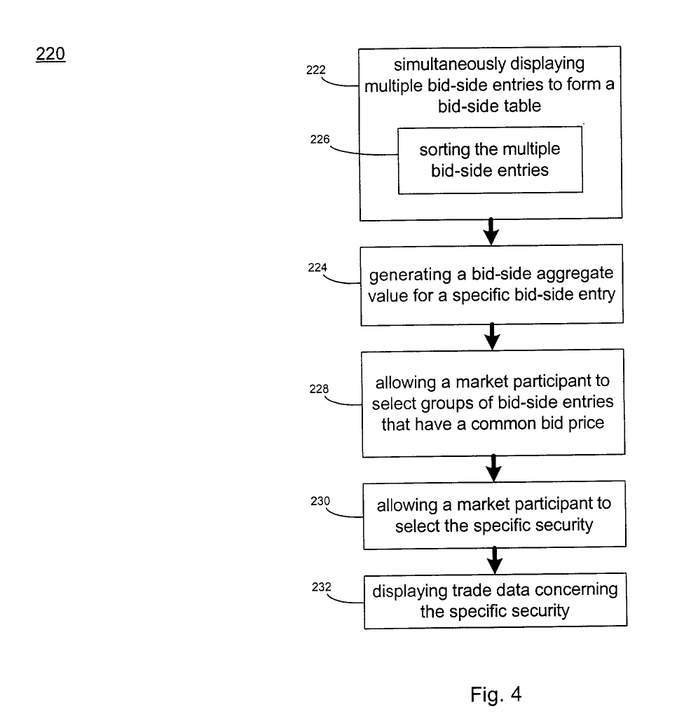

Referring to FIG. 4, there is shown an aggregated display method 220. Multiple bid-side entries are simultaneously displayed 222 to form a bid-side table. Each of these bid-side entries is in a multi-column format, concerns a specific security that is sought for purchase by a market participant on a securities market, and includes a market participant identifier, a lot size, and a bid price.

A bid-side aggregate value is generated 224 for a specific bid-side entry. This bid-side aggregate value is equal to the lot size of that specific bid-side entry summed with the lot sizes of all preceding bid-side entries included in the bid-side table.

The bid-side entries are sorted 226 in accordance with a user-defined sorting parameter. A market participant is allowed 228 to select groups of bid-side entries that have a common bid price, and is also allowed 230 to select the specific security. Additionally, trade data is displayed 232 concerning the specific security.

The system described herein is not limited to the hardware embodiment described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Embodiments of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Embodiments of the system may also be implemented using integrated circuit blocks referred to as main memory, cache memory, or other types of memory that store electronic instructions to be executed by a microprocessor or store data that may be used in arithmetic operations.

A number of embodiments of the invention have been described. Nevertheless, it will be understood that various modifications may be made without departing from the spirit and scope of the invention.

What is claimed is:

1. An aggregated display process comprising:
an ask-side display process for displaying, in a multi-column format, an ask-side entry for a specific security that is offered for sale by a market participant on a securities market, wherein the ask-side entry includes a market participant identifier, a lot size, and an ask price, the ask-side display process including a tabular display process for simultaneously displaying multiple ask-side entries in an ask-side table; and
an ask-side aggregate calculation process for generating an ask-side aggregate value for a specific ask-side entry, wherein the ask-side aggregate value is equal to the lot size of the specific ask-side entry summed with the lot sizes of all preceding ask-side entries included in the ask-side table.

2. The aggregated display process of claim 1 wherein the ask-side display process includes a tabular sorting process for sorting the multiple ask-side entries in accordance with a user-defined sorting parameter.

3. The aggregated display process of claim 2 wherein the user-defined sorting parameter is chosen for the group consisting of: the market participant identifier; the lot size; and the ask price.

4. The aggregated display process of claim 1 further comprising an ask-side selection process for allowing a market participant to select one or more groups of ask-side entries that have a common ask price.

5. The aggregated display process of claim 1 further comprising a security selection process for allowing a market participant to select the specific security.

6. The aggregated display process of claim 1 further comprising a security data display process for displaying trade data concerning the specific security.

7. The aggregated display process of claim 6 wherein the trade data includes a trade volume amount, a low trade amount, and a high trade amount.

8. An aggregated display process comprising:
a bid-side display process for displaying, in a multi-column format, a bid-side entry for a specific security that is sought for purchase by a market participant on a securities market, wherein the bid-side entry includes a market participant identifier, a lot size, and a bid price; the bid-side display process including a tabular display process for simultaneously displaying multiple bid-side entries in a bid-side table; and
a bid-side aggregate calculation process for generating a bid-side aggregate value for a specific bid-side entry, wherein the bid-side aggregate value is equal to the lot size of the specific bid-side entry summed with the lot sizes of all preceding bid-side entries included in the bid-side table.

9. The aggregated display process of claim 8 wherein the bid-side display process includes a tabular sorting process for sorting the multiple bid-side entries in accordance with a user-defined sorting parameter.

10. The aggregated display process of claim 9 wherein the user-defined sorting parameter is chosen for the group consisting of: the market participant identifier; the lot size; and the bid price.

11. The aggregated display process of claim 8 further comprising a bid-side selection process for allowing a market participant to select one or more groups of bid-side entries that have a common bid price.

12. The aggregated display process of claim 8 further comprising a security selection process for allowing a market participant to select the specific security.

13. The aggregated display process of claim 8 further comprising a security data display process for displaying trade data concerning the specific security.

14. The aggregated display process of claim 13 wherein the trade data includes a trade volume amount, a low trade amount, and a high trade amount.

15. An aggregated display method comprising:
simultaneously displaying multiple ask-side entries to form an ask-side table, wherein each ask-side entry is in a multi-column format, concerns a specific security that is offered for sale by a market participant on a securities market, and includes a market participant identifier, a lot size, and an ask price; and
generating an ask-side aggregate value for a specific ask-side entry, wherein the ask-side aggregate value is equal to the lot size of that specific ask-side entry summed with the lot sizes of all preceding ask-side entries included in the ask-side table.

16. The aggregated display method of claim 15 wherein simultaneously displaying multiple ask-side entries includes sorting the multiple ask-side entries in accordance with a user-defined sorting parameter.

17. The aggregated display method of claim 15 further comprising allowing a market participant to select one or more groups of ask-side entries that have a common ask price.

18. The aggregated display method of claim 15 further comprising allowing a market participant to select the specific security.

19. The aggregated display method of claim 15 further comprising displaying trade data concerning the specific security.

20. An aggregated display method comprising:
simultaneously displaying multiple bid-side entries to form a bid-side table, wherein each bid-side entry is in a multi-column format, concerns a specific security that is sought for purchase by a market participant on a securities market, and includes a market participant identifier, a lot size, and a bid price; and
generating a bid-side aggregate value for a specific bid-side entry, wherein the bid-side aggregate value is equal to the lot size of that specific bid-side entry summed with the lot sizes of all preceding bid-side entries included in the bid-side table

21. The aggregated display method of claim 20 wherein displaying a bid-side entry includes sorting the multiple bid-side entries in accordance with a user-defined sorting parameter.

22. The aggregated display method of claim 20 further comprising allowing a market participant to select one or more groups of bid-side entries that have a common bid price.

23. The aggregated display method of claim 15 further comprising allowing a market participant to select the specific security.

24. The aggregated display method of claim 15 further comprising displaying trade data concerning the specific security.

25. A computer program product residing on a computer readable medium having a plurality of instructions stored thereon which, when executed by the processor, cause that processor to:
simultaneously display multiple ask-side entries to form an ask-side table, wherein each ask-side entry is in a multi-column format, concerns a specific security that is offered for sale by a market participant on a securities market, and includes a market participant identifier, a lot size, and an ask price; and
generate an ask-side aggregate value for a specific ask-side entry, wherein the ask-side aggregate value is equal to the lot size of that specific ask-side entry summed with the lot sizes of all preceding ask-side entries included in the ask-side table

26. The computer program product of claim 25 wherein instructions to simultaneously display multiple ask-side entries further includes instructions to sort the multiple ask-side entries in accordance with a user-defined sorting parameter.

27. The computer program product of claim 25 further comprising instructions to allow a market participant to select one or more groups of ask-side entries that have a common ask price.

28. A computer program product residing on a computer readable medium having a plurality of instructions stored thereon which, when executed by the processor, cause that processor to:
simultaneously display multiple bid-side entries to form a bid-side table, wherein each bid-side entry is in a multi-column format, concerns a specific security that is sought for purchase by a market participant on a securities market, and includes a market participant identifier, a lot size, and a bid price; and
generate a bid-side aggregate value for a specific bid-side entry, wherein the bid-side aggregate value is equal to the lot size of that specific bid-side entry summed with the lot sizes of all preceding bid-side entries included in the bid-side table

29. The computer program product of claim 28 wherein instructions to simultaneously display multiple bid-side entries further includes instructions to sort the multiple bid-side entries in accordance with a user-defined sorting parameter.

30. The computer program product of claim 28 further comprising instructions to allow a market participant to select one or more groups of bid-side entries that have a common ask price.
